(19) United States
(12) Patent Application Publication
(10) Pub. No.: US 2005/0117676 A1
(43) Pub. Date: Jun. 2, 2005

(54) Device and method for identifying interference source in wireless communications

(76) Inventor: I-Ru Liu, Taipei City (TW)

Correspondence Address: SUPREME PATENT SERVICES, POST OFFICE BOX 2339, SARATOGA, CA, 95070, US

(21) Appl. No.: 10/763,671

(22) Filed: Jan. 24, 2004

(30) Foreign Application Priority Data
Nov. 28, 2003 (TW) 92133472

(51) Int. Cl. H04L 1/00

(52) U.S. Cl. 375/346

(57) ABSTRACT

A device for identifying interference source in wireless communications is provided, including a correlation compound module, a matching and screening module, a statistical analysis module, and a match identification module. The correlation compound module uses the time of arrival (TOA) of the burst as the synchronization basis to compound the correlated frequency word, time difference of arrival (TDOA) word, amplitude word and angle of arrival (AOA) word to form a burst descriptor word (BDW). The matching and screening module uses the BWD to match the burst library to screen out the non-interference sources. The statistic analysis module uses the screened outcome for statistical analysis, and obtains a source discriminator file (SDF). The matching and identification module uses the SDF to search the interference source library for matching and obtains an identification result.

### FIELD OF THE INVENTION

The present invention relates to a method for identifying interference source and, more particularly, to a method for identifying interference source in wireless communications by library matching.

### BACKGROUND OF THE INVENTION

Unlicensed communication bands are generally categorized as unlicensed Industrial Scientific and Medical (ISM) Band and Unlicensed National Information Infrastructure (UNII) Band. The ISM Band usually uses the frequency 902-928 MHz and 2.4-2.4835 GHz, while the UNII Band uses 5.15-5.35 GHz and 5.725-5.825 GHz.

In these unlicensed bands, each signal source uses different frequencies, for example, the Wireless LAN per IEEE 802.11b/g standards uses 2400-2483.5 MHz, per IEEE 802.11a, it uses 5150-5350 MHz and 5725-5825 MHz, microwave ovens use 2414-2465 MHz, cordless telephones use 2401.5-2478 MHz, Bluetooth uses 2402-2480 MHz, and so on.

Under most circumstances, the unlicensed communication environment is filled with various types of communication equipments and signal sources. These equipments and sources interfere with one another, and thus become one another's interference source. In a communication environment, both jamming and interference are unwanted signals to wireless communication equipments, and will degrade the communication quality of the equipments. Therefore, it is necessary to provide the wireless communication equipments with measuring, identifying, and supporting to rid of these unwanted signals in order to improve the transmission effect and communication quality.

However, most conventional arts only work on radiated signals with known modulating signatures for detection and analysis. For other types of interference sources without known modulating signatures, the conventional techniques are unable to demodulate.

### SUMMARY OF THE INVENTION

The main object of the present invention is to provide an interference source identification system for wireless communications to identify and to support in excluding unwanted signals in wireless communications and to improve the transmission performance of wireless communication equipments.

Based on the aforementioned object, the interference source identification system for wireless communications disclosed in the present invention includes a direction finding antenna, a converter, a receiver, an interference source identification device, and an output device with a control interface. The direction finding antenna is for receiving a radio frequency (RF) signal, the converter is to convert the RF signal into an intermediate frequency (IF) signal, and the receiver processes the IF signal into a digital signal. The interference source identification device uses the digital words of received frequency to search an interference source library for matching and generates an interference source identification result. Finally, the output device with a control interface outputs the interference source identification result. Based on the identification result, the output device outputs information regarding the interference source, including at least the name of the interference source, frequency coverage, number of bands, and frequency types. Through the control interface, the output device can adjust the parameters used in the interference source identification system for wireless communications.

The aforementioned interference source identification device further includes a correlation compound module, a matching and screening module, a statistical analysis module, and a matching and identification module. The correlation compound module uses the time of arrival (TOA) of the burst as the synchronization basis to compound the correlated frequency word, time difference of arrival (TDOA) word, amplitude word and angle of arrival (AOA) word to form a burst descriptor word (BDW). The matching and screening module uses the BDW to match the burst library to screen out the non-interference sources. The statistical analysis module uses the screened outcome for statistical analysis, and obtains a source discriminator file (SDF). The matching and identification module uses the SDF to search the interference source library for matching and obtains an identification result.

These and other objects, features and advantages of the invention will be apparent to those skilled in the art, from a reading of the following brief description of the drawings, the detailed description of the preferred embodiment, and the appended claims.

### BRIEF DESCRIPTION OF THE DRAWINGS

FIG. 1 shows a diagram of an interference source identification system for wireless communications of the present invention.

FIG. 2 shows a flow diagram of an interference source identification device of the present invention.

FIG. 3 shows a table of ranges of parameters of the present invention.

FIGS. 4A and 4B show flow diagrams of the process of matching and screening used in the matching and screening module of the present invention.

FIGS. 5A-5C show flow diagrams of the process of statistical analysis used in the statistical analysis module of the present invention.

FIGS. 6A and 6B show flow diagrams of the process of matching and identification used in the matching and identification module of the present invention.

### DETAILED DESCRIPTION OF THE PREFERRED EMBODIMENT

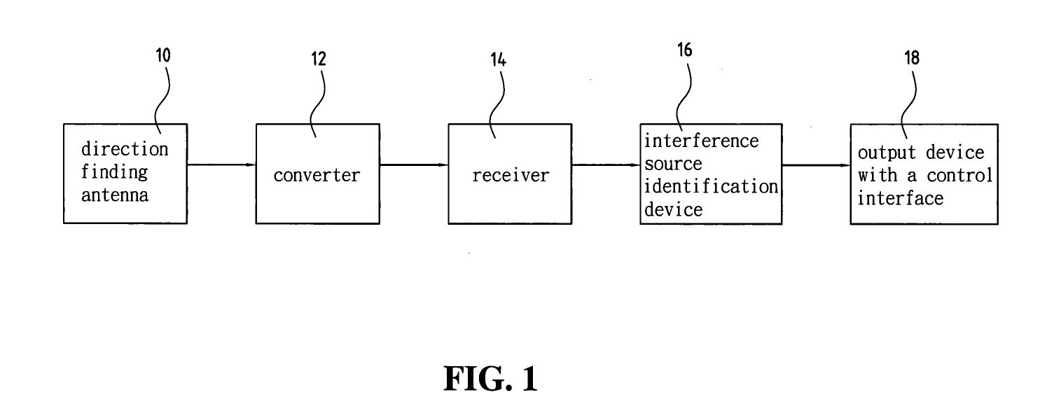

FIG. 1 shows a diagram of the present invention. As shown in FIG. 1, the interference source identification system comprises a direction finding antenna 10, a converter 12, a receiver 14, an interference source identification device 16, and an output device 18 with a control interface. Interference source identification device 16 is the core component of the present invention for identifying the interference source. The following first describes the components and the role they play in the present invention. The details of the interference source identification device 16 will be described later.

Direction finding antenna 10 is used for receiving and processing radio frequency (RF) to provide the back stage and extract the directional information of the interference source. Converter 12 is for converting the RF signals into intermediate frequency (IF) signals. Receiver 14 measures and calculates the frequency, time difference of arrival (TDOA), amplitude, and angle of arrival (AOA), and output digital words, such as frequency word, TDOA word, amplitude word, and AOA word so that they can be matched and screened against an interference source identification library to generate an interference source identification result. Output device 18 uses the interference source identification result to output the information of the interference source, including at least the name of the interference source, frequency coverage, number of bands, and frequency types. Output device 18 also uses its control interface to adjust the parameters of the components of the interference source identification system. The following describes the core identification device of the present invention, interference source identification device 16.

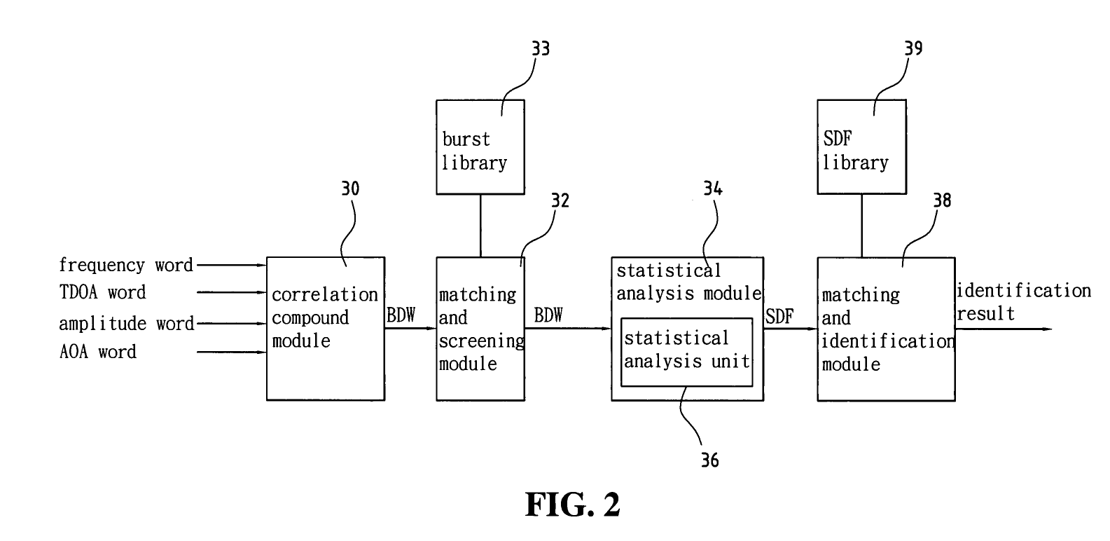

FIG. 2 shows a flow diagram of interference source identification device 16. As shown in FIG. 2, interference source identification device 16 comprises a correlation compound module 30, a matching and screening module 32, a statistical analysis module 34, and a matching and identification module 38. Correlation compound module 30 compounds the frequency word, TDOA word, amplitude word, and AOA word into a burst descriptor word (BDW) describing the parameters of the signals. Matching and screening module 32, statistical analysis module 34, and matching and identification module 38 use a similar approach in matching and analyzing. Matching and screening module 32 uses the BDW to match and screen and obtain BDWs of possible interference sources. Statistical analysis 34 processes the BDWs into a source discriminator file (SDF). Finally, matching and identification module 38 uses a more strictly matching method for categorizing SDF into specific interference sources and unknown interference sources.

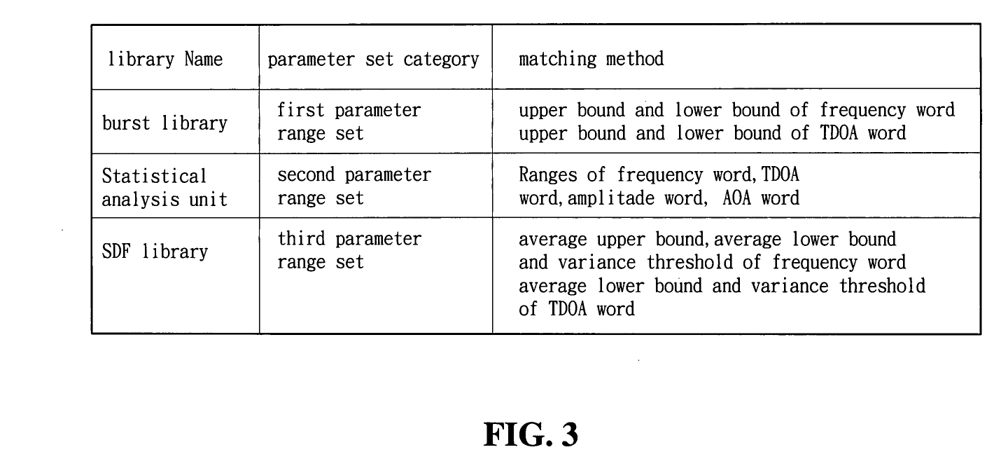

FIG. 3 shows a table of parameter ranges of the present invention. As shown in FIG. 2, the matching and analysis performed by the last three components are based on the parameter ranges shown in FIG. 3. Matching and screening module 32 uses the first parameter range set of a plurality of range sets stored in a wireless burst library 33 for matching and screening, as shown in FIG. 3 as an upper bound and a lower bound of the frequency word and TDOA word, respectively. Statistical analysis unit 36 of statistical analysis module 34 uses the second parameter range set, including parameter range of a matching frequency word, a TDOA word, an amplitude word, and an AOA word to perform statistical analysis. Finally, matching and identification module 38 uses the third parameter range set stored in interference source identification library 39 to perform matching and identification. The third parameter range set is shown in FIG. 3 as the average upper bound, average lower bound and variance threshold of the frequency word and TDOA word, respectively. The following describes the details of the matching and analysis process performed in the three different components.

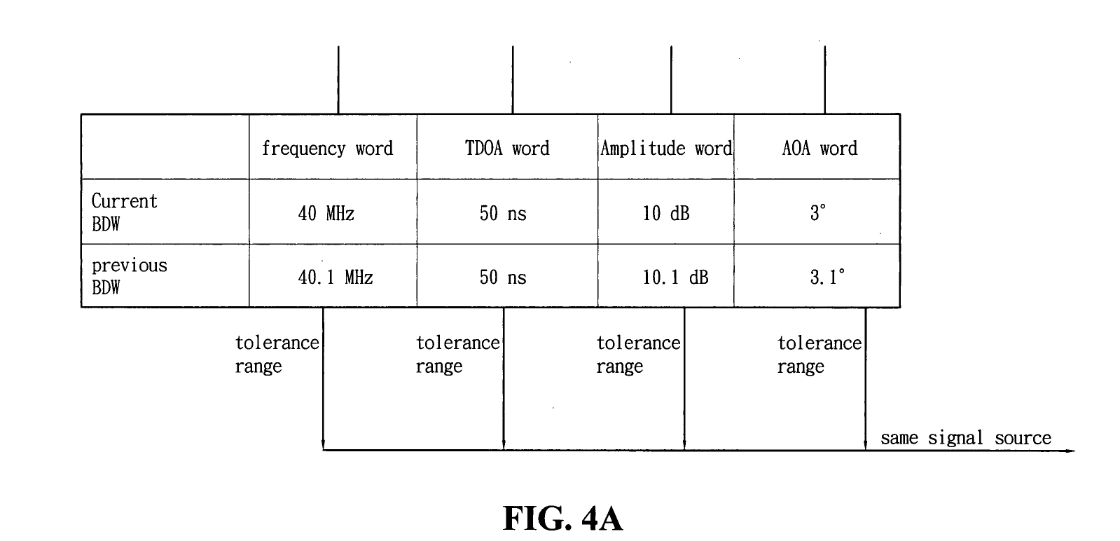

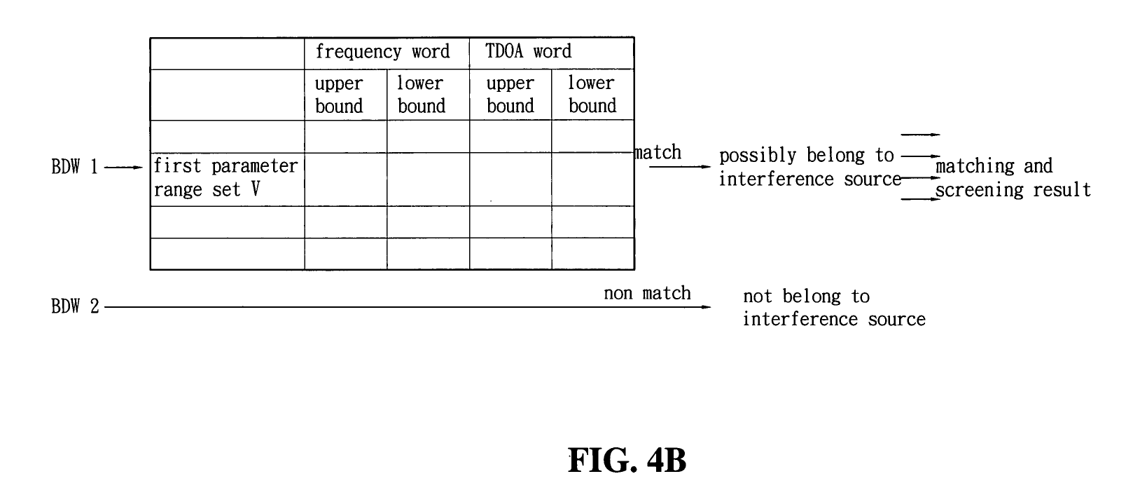

FIGS. 4A and 4B show flow diagrams of the matching and screening process in the matching and screening module. As shown in FIG. 4A, the current BDW and the previous BDW compare their frequency word, TDOA word, amplitude word and AOA word with each other. If all the compared pairs of words are within the tolerance range, the current BDW and the previous BDW are considered as from the same interference source. Therefore, when a previous BDW is identified by matching and screening module 32 of FIG. 2 as a BDW from an interference source, the current BDW can also be directly identified as from the same interference source. On the other hand, if the previous BDW is identified as not belonging to an interference source, the current BDW is not belonging to an interference source, either. Matching and screening module 32 uses the aforementioned approach to increase the matching and screening efficiency.

As shown in FIG. 4B, matching and screening module 32 compares the signal parameters of the BDW with the frequency word and TDOA word, which are irrelevant to relative space, for matching and screening. In FIG. 4B, matching and screening module 32 identifies that BWD 1 is from a possible interference source by identifying the frequency word of BDW 1 falling within the upper and lower bounds of frequency word specified by the first parameter range set V stored in burst library 33, and the TDOA word of BDW 1 falling within the upper and lower bounds of TDOA word specified by the first parameter range set V stored in burst library 33.

In addition, as shown in FIG. 4B, BDW 2 is identified as not from a possible interference source because the frequency word and TDOA word of BDW 2 do not match upper and lower bounds specified any first parameter range set stored in burst library 33. Therefore, BDW 2 is screened out. The next will describe how statistical analysis module 34 of FIG. 2 performs statistical analysis based on the result of a plurality of interference sources obtained by matching and screening module 32.

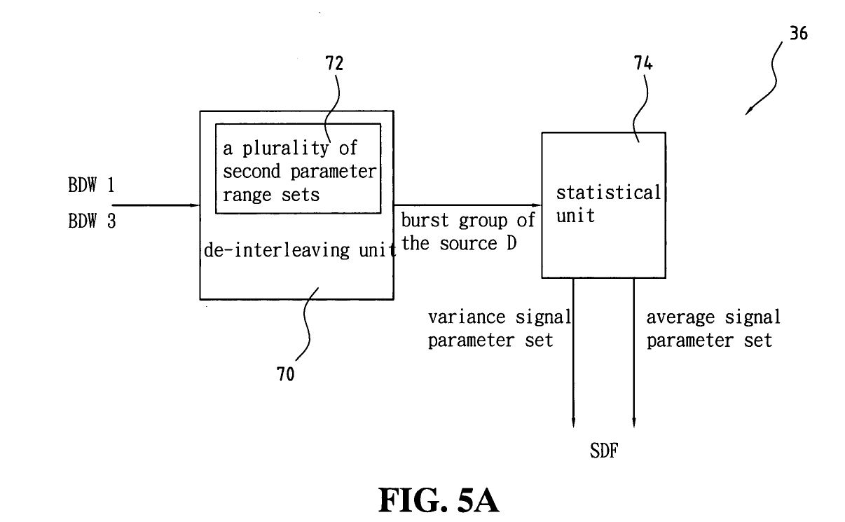

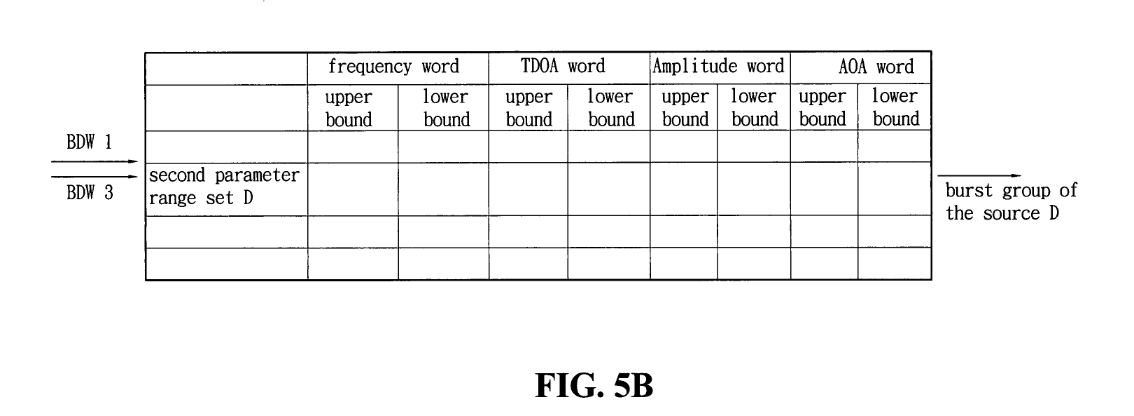

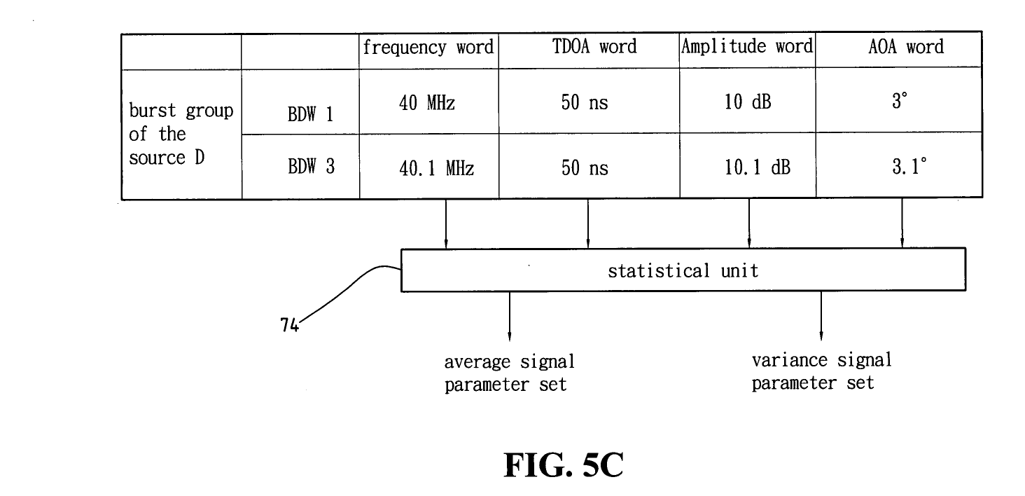

FIG. 5A-5C show flow diagrams of the analysis process performed by statistical analysis module 34. As shown in FIG. 2, statistical analysis module uses its statistical analysis unit 36 to analyze and generate SDF, which comprises corresponding average signal parameter set and variance signal parameter set. Statistical analysis unit 36 further comprises a de-interleaving unit 70 and a statistical unit 74. De-interleaving unit 70 categorizes BDWs into burst groups of same source, and statistical unit 74 generates the corresponding average signal parameter set and variance signal parameter set, based on the burst groups.

The aforementioned average signal parameter set is composed of an average frequency word, an average TDOA word, an average amplitude word, and an average AOA word, while the variance signal parameter set is composed of a variance frequency word, a variance TDOA word, a variance amplitude word, and a variance AOA word. As shown in FIG. 5A, the average frequency word and the average TDOA word in the SDF corresponding to burst group D are determined by the plurality of frequency words of BDWs belonging to burst group D. Other parameters in the average signal parameter set and the variance signal parameter set are also determined by the corresponding plurality of BDWs belongs to burst group D.

The variance frequency word is the variance calculated by statistical unit 74 using BDW 1 and BDW3 of burst group D, and the average frequency word is the average also calculated by statistical unit 74 using BDW 1 and BDW 3 of burst group D. The following describes how de-interleaving unit 70 uses a plurality of second parameter sets 72 to categorize the BDW 1 and BDW 3 into the same burst group D, and further generates an SDF.

As shown in FIG. 5B, if the parameters of the signal parameter sets of BDW1 and BDW 3 fall within the upper and lower bounds of the parameters specified by the second parameter range set, both BDW 1 and BDW 3 are identified as belonging to the burst group D from the same interference source.

As shown in FIG. 5C, statistical unit 74 calculates the average of the parameters of BDW 1 and BDW 3 of burst group D to obtain the average signal parameter set, calculates the variance of the parameters to obtain the variance signal parameter set, and further combine both to obtain the SDF corresponding to burst group D. The following describes how matching and identification module 38 of FIG. 2 uses the SDF to generate an identification result.

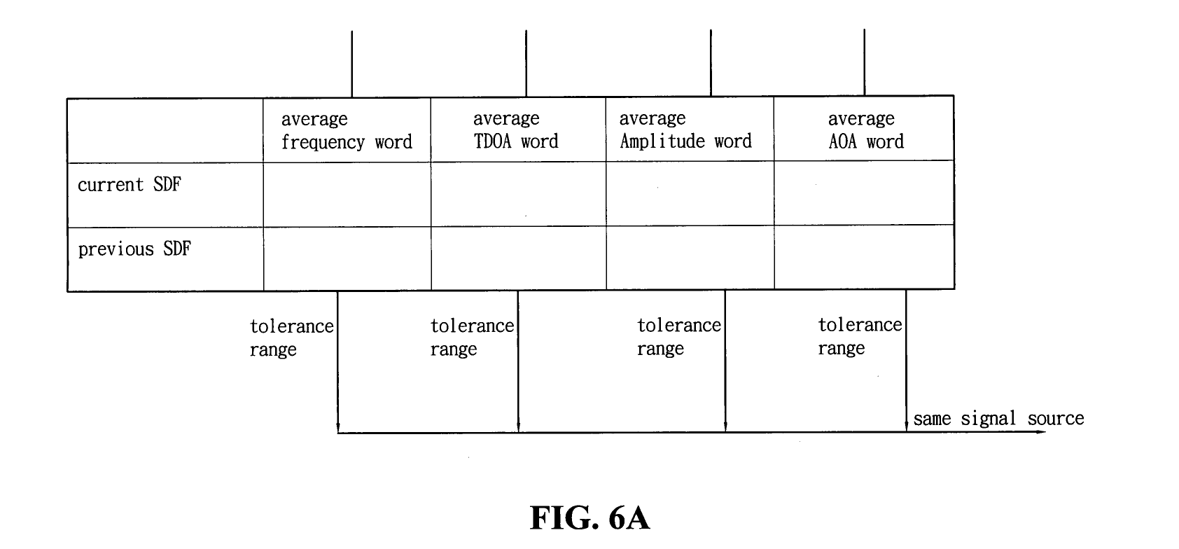

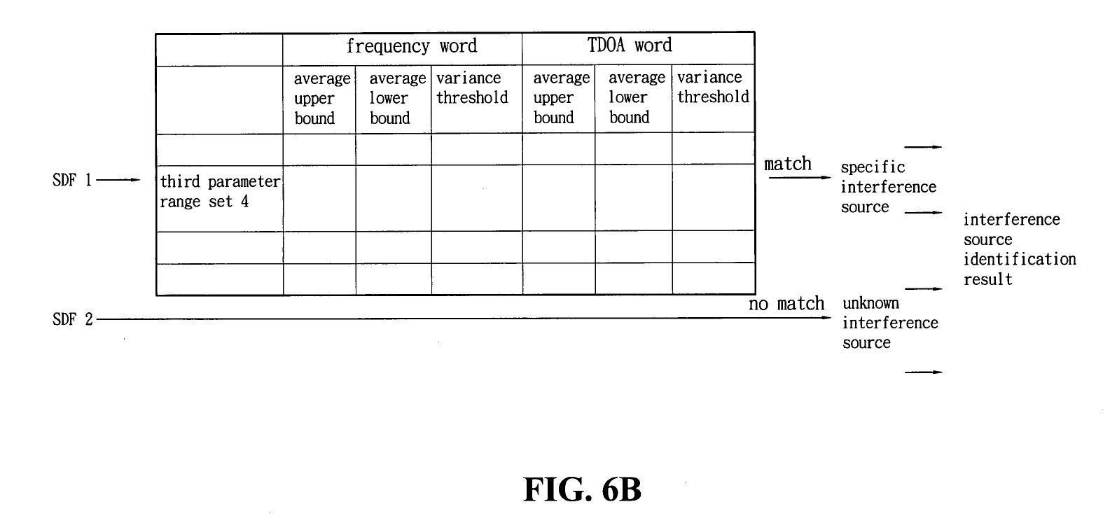

FIGS. 6A and 6B show flow diagrams of the process of matching and identification performed by matching and identification module. As shown in FIG. 6A, the current SDF and the previous SDF compare the average frequency word, average TDOA word, average amplitude word, and average AOA word with each other. If the corresponding parameters are within the tolerance range, as shown in FIG. 6A, the current SDF is identified as from the same interference source as the previous SDF. Therefore, if the previous SDF is identified by matching and identification module 38 of FIG. 2 as from a specific type of interference source, the current SDF is also identified as from the same type of interference source. On the other hand, if the previous SDF is identified as from an unknown type of interference type, the current SDF is identified as from an unknown type of interference source. Therefore, matching and identification module 38 can use the aforementioned method to increase the matching and identification efficiency.

As shown in FIG. 6B, matching and identification module 38 compares the average signal parameter sets of the SDF with the upper and lower bounds of the average frequency word and average TDOA word, which are both irrelevant to the relative space, and the variance signal parameter set of the SDF with the variance thresholds of variance frequency word and variance TDOA word. In FIG. 6B, SDF 1 is identified as belonging to a specific type of interference source because the average frequency word of SDF 1 falls within the range between the average upper and average lower bounds of the frequency word specified by the third parameter range set 4 stored in SDF library 39, the variance frequency word meets the variance threshold of specified by the third parameter range set 4 stored in SDF library 39, the average TDOA word of SDF 1 falls within the range between the average upper and average lower bounds specified of the TDOA word by the third parameter range set 4 stored in SDF library 39, and the variance TDOA word meets the variance threshold of specified by the third parameter range set 4 stored in SDF library 39. The result is recorded in the interference source identification result.

On the other hand, as shown in FIG. 6B, SDF 2 is identified as belonging to an unknown type of interference source because the average frequency word, the variance frequency word, the average TDOA word, and the variance TDOA word of SDF 1 do not match any ranges or thresholds specified by any third parameter range set 4 stored in SDF library 39. The result is recorded in the interference source identification result.

In summary, interference source identification device 16 of the interference source identification system for wireless communications disclosed by the present invention can use matching and screening module 32, statistical analysis module 34 and matching and identification module 38 to identify the interference source of the unwanted signals and improve the transmission performance of the wireless communication equipments.

While the invention has been described in connection with what is presently considered to the most practical and preferred embodiment, it is to be understood that the invention is not to be limited to the disclosed embodiment, but on the contrary, is intended to cover various modifications and equivalent arrangement included within the spirit and scope of the appended claims.

1. An interference source identification method for wireless communications, comprising the steps of:
using time of arrival of a wireless burst as a synchronization basis to compound synchronously a frequency word, a time different of arrival (TDOA) word, an amplitude word, and an angle of arrival (AOA) word of said burst into a burst descriptor word (BDW) having a signal parameter set, said signal parameter set comprising said frequency word, said TDOA word, said amplitude word, and said AOA word;
comparing said BDW with a previous said BDW and a burst library to screen out non-interference signals and obtain a matched result, said matched result comprising a plurality of said BDWs of interference sources;
using a statistical analysis process to categorize said BDWs of said matched result into a source discriminator file (SDF); and
comparing said SDF with a previous said SDF and a SDF library to generate an interference source identification result.

2. The method as claimed in claim 1, wherein said comparing said BDW with a previous said BWD step is to compare said frequency word, said TDOA word, said amplitude word, and said AOA word of said BDW and those of said previous BDW to determine if all respective comparisons are within the same tolerance range so that said BDW and said previous BDW can be considered as from the same interference source.

3. The method as claimed in claim 1, wherein said burst library defines a plurality of first parameter range sets, and each said first parameter range set further comprises an upper bound and a lower bound for said frequency word and said TDOA word, respectively.

4. The method as claimed in claim 3, wherein said comparing said BDW and said burst library step is to compare said frequency word and said TDOA word with said upper bound and said lower bound for said frequency word and said TDOA word specified in said first parameter range sets in said burst library to determine if said frequency word and said TDOA word are within the range specified by said upper bounds and said lower bounds to be considered as from a specific interference source.

5. The method as claimed in claim 3, wherein said comparing said BDW and said burst library step is to compare said frequency word and said TDOA word with said upper bound and said lower bound for said frequency word and said TDOA word specified in said first parameter range sets in said burst library to determine if said frequency word and said TDOA word are not within the range specified by said upper bounds and said lower bounds so that said BDW can be considered as from a non-interference source, and can be excluded for further processing.

6. The method as claimed in claim 3, wherein said comparing said BDW and said burst library step is to determine if said BDW is from an interference source based on the result that said BDW and said previous BDW are determined to be from the same signal source.

7. The method as claimed in claim 4, wherein said statistical analysis process further comprises the steps of:
de-interleaving said interleaved bursts in accordance with a plurality of parameter range specified by a second parameter range set to obtain a plurality of burst groups of the source, said signal parameter set of each said BDW of said burst group of the source can fall within the upper bound and the lower bound of said parameter range of said second parameter range set of said burst group of the source; and
averaging each said parameter of said signal parameter set of each said BDW of said burst group of the source to obtain an average signal parameter set, and including said average signal parameter set in a said corresponding SDF of said burst group of the source, said average parameter set comprising an average frequency word, an average TDOA word, an average amplitude word, and an average AOA word.

8. The method as claimed in claim 7, wherein said SDF has a variance signal parameter set, said variance signal parameter set further comprises a variance frequency word, a variance TDOA word, a variance amplitude word, a variance AOA word of said signal parameter, each variance of said variance signal parameter set is the variance of said parameter of said signal parameter set of a plurality of said BDW of said burst group of the source.

9. The method as claimed in claim 9, wherein said SDF library defines a plurality of third parameter range sets, each of said third parameter sets comprises an average upper bound, an average lower bound, and a variance threshold of said frequency word and said TDOA word, respectively.

10. The method as claimed in claim 8, wherein said comparing said SDF and said previous SDF step is to identify said SDF and said previous SDF are from the same signal source when said SDF and said previous SDF have the difference in said average frequency words, said average TDOA words, said average amplitude words, said average AOA words, said variance frequency words, said variance TDOA words, said variance amplitude words, and said variance AOA words all falling within a tolerance range.

11. The method as claimed in claim 9, wherein said comparing said SDF and said SDF library step to identify said SDF as from a specific interference source when said average frequency word and said average TDOA word of said SDF are within the range specified by said upper and lower bounds of said average frequency word and said average TDOA word specified in any said third parameter range sets in said SDF library, and said variance frequency word and said variance TDOA word of said SDF are within the range specified by said variance thresholds of said frequency word and said TDOA word specified in any said third parameter range sets in said SDF library.

12. The method as claimed in claim 9, wherein said comparing said SDF and said SDF library step to identify said SDF as from an unknown interference source when said average frequency word and said average TDOA word of said SDF are not within the range specified by said upper and lower bounds of said average frequency word and said average TDOA word specified in any said third parameter range sets in said SDF library, and said variance frequency word and said variance TDOA word of said SDF are not within the range specified by said variance thresholds of said frequency word and said TDOA word specified in any said third parameter range sets in said SDF library.

13. The method as claimed in claim 10, wherein said comparing said SDF and said SDF library step is to determine if said SDF is from an interference source based on the result that said SDF and said previous SDF are determined to be from the same signal source.

14. A device for identifying interference source in wireless communications, comprising:
a correlation compound module, said correlation compound module using the arrival time of a burst as a synchronization basis to compound a frequency word, a TDOA word, an amplitude word, and an AOA word of said burst into a BDW having a signal parameter set, said signal parameter set comprising said frequency word, said TDOA word, said amplitude word, and said AOA word;
a matching and screening module, said matching and screening module comparing said BDW with a previous BDW and a burst library to screen out non-interference sources and obtain a matching and screening result;
a statistical analysis module, said statistical analysis module categorizing said BDWs of said matching and screening result to obtain an SDF; and
a matching and identification module, said matching and identification module comparing said SDF with a previous SDF and a SDF library to obtain an identification result.

15. The device as claimed in claim 14, wherein said burst library defines a plurality of first parameter range sets, each of said first parameter sets comprising an upper bound and an lower for said frequency word and TDOA word, respectively.

16. The device as claimed in claim 16, wherein said statistical analysis module comprises:
a de-interleaving unit, said de-interleaving unit is to de-interleave interleaved bursts in accordance with a plurality of parameter range defined by a second parameter range set to obtain a plurality of burst groups of the source, each said parameter of each said BDW of said burst group of the source falling within said upper bound and said lower bound specified by said burst group of the source; and
a statistical unit, said statistical unit using said signal parameters of each said BDW of said burst group of source to calculate an average signal parameter set and a variance signal parameter set, and assigning said average signal parameter set and said variance signal parameter set to said SDF corresponding to said burst group of source, said average signal parameter set further comprising an average frequency word, an average TDOA word, an average amplitude word, and an average AOA word, and said variance signal parameter set further comprising a variance frequency word, a variance TDOA word, a variance amplitude word, and a variance AOA word.

17. The device as claimed in claim 14, wherein said SDF library defines a plurality of third parameter range sets, each of said third parameter sets comprises an average upper bound, an average lower bound and a variance threshold of said frequency word and TDOA word, respectively.

18. An interference source identification system for wireless communications, comprising:
a direction finding antenna for receiving and processing radio frequency (RF) signals and providing back stage for extracting directional information of an interference source;
a converter for converting said RF signals into intermediate frequency (IF) signals;
a receiver for measuring and calculating frequency, time difference of arrival (TDOA), amplitude, and angle of arrival (AOA) and outputting digitized frequency word, TDOA word, amplitude word, and AOA word;
an interference source identification device for generating an interference source identification result based on comparing said frequency word, said TDOA word, said amplitude word, and said AOA word with an interference source library; and
an output device with a control interface, said output device for outputting information of an interference source comprising at least a name, a frequency coverage, number of bands, frequency types based on said identification result, and using said control interface to adjust said component parameters in said system.
